(19) United States
(12) Patent Application Publication
(10) Pub. No.: US 2018/0215492 A1
(43) Pub. Date: Aug. 2, 2018

(54) INLINE PRINTING WITH PACKAGING MACHINE

(71) Applicant: TETRA LAVAL HOLDINGS & FINANCE S.A., Pully (CH)

(72) Inventors: Gustavo Barros, Modena (IT); Lars Palm, Akarp (SE); Lars Henriksson, Akarp (SE); Jon Mikaelsson, Råå (SE); Camilla Joscelyne, Södra Sandby (SE); Lars-Åke Näslund, Furulund (SE); Joakim Tuvesson, Höllviken (SE)

(21) Appl. No.: 15/738,355

(22) PCT Filed: Jun. 16, 2016
(86) PCT No.: PCT/EP2016/063925

§ 371 Date: Dec. 20, 2017

(30) Foreign Application Priority Data
Jun. 22, 2015 (SE) 1550859-1

(51) Int. Cl. B65B 61/02; B65B 41/12; B65B 9/10; B65B 55/08; B41J 3/407

(52) U.S. Cl. CPC B65B 61/025; B65B 41/12; B41J 3/407; B65B 55/08; B65B 9/10

(57) ABSTRACT

An arrangement adapted to package a liquid consumable product in a package. The arrangement can include an infeed to provide prepared packaging material having a first side and a second side adapted to be in contact with the consumable product, a digital printing system coupled to the infeed and adapted to print at least one color onto at least a portion of the first side of the prepared packaging material, and a packaging machine coupled to an outfeed of the digital printing system and adapted to provide a package from said prepared packaging material. The package is filled with the consumable product, and the printed first side of the prepared packaging material does not get in contact with the second side during transport of the printed prepared packaging material from the digital printing system to the packaging machine.

### TECHNICAL FIELD

The present invention relates generally to an arrangement to package a liquid consumable product in a package. More particularly, the present invention relates to an arrangement as defined in the introductory parts of claim 1 and claim 2.

### BACKGROUND ART

In the packing industry for packing food content, packages are often made by multi-layer material, e.g. carton based multi-layer materials, that is folded and sealed into packages into which food content is placed. In the packaging process it is important to keep the material that comes into contact with the food clean so as to not compromise the food quality. The inner side of the packaging material that is in direct food contact has to be hygienic and the migration performance of the total assembly, including the packaging material, needs to live up to food safety standards. For some food packing machines of carton based packages, the packaging material, e.g. complex multi-layer packaging material, are provided in large rolls with packaging material where each roll or reel contains packaging material for a large number of packages, often thousands of packages.

The large reels with packaging material are pre-printed according to the food product that is filled into the package. In relation to the reels it must be ensured, that potential transfer from printing ink components onto the food contact layer meets food safety requirements.

Using pre-printed reels does, however, make it expensive to produce small volumes of a package for a product, makes it difficult to make individual designs to packages, since the complex multi-layer material has to be pre-fabricated, and makes it practically impossible to make last minute design adaptations/changes. During the fabrication process, among other steps, the material is printed and provided with a final polymer layer on top of the print. The only print added to the pre-printed material is usually the expiry date that is added before or after the package is filled with food by a filling machine.

There is thus a need for an improved packing arrangement which allows customized printing of packages or packages with unique printing on each package without the need of ordering large quantities of pre-printed packaging material.

### SUMMARY OF THE INVENTION

It is an object of the present invention to improve the current state of the art, to solve the above problems, and to provide an arrangement to package a liquid consumable product in a package with a customized print. These and other objects are achieved by an arrangement adapted to package a liquid consumable product in a package. The arrangement comprises an infeed to provide prepared packaging material having a first side and a second side adapted to be in contact with the consumable product, the food contact side, a digital printing system coupled to the infeed and adapted to print at least one color onto at least a portion of the first side of the prepared packaging material, and a packaging machine coupled to an outfeed of the digital printing system and adapted to provide a package from said prepared packaging material. The package is filled with the consumable product, and the printed first side of the prepared packaging material does not get in contact with the second side during transport of the printed prepared packaging material from the digital printing system to the packaging machine. With the digital printing system included in the arrangement a number of problems are eliminated from the packaging process. The packaging material is no longer required to be pre-printed or totally pre-printed before it enters into the packaging arrangement. In turn, the printing of the packaging material can be customized to a larger extent and smaller volumes of a certain product may accordingly be packaged and printed using the arrangement compared to prior art. Portions of the package may thus be pre-printed, and other portions of the package may be customary printed. So called, hybrid printing is thereby made possible. Also, since the first side of the packaging material does not come in contact with the second side of the packaging material, the risk for set-off of ink is eliminated, which eliminates also the risk of migration in the subsequent phase when the second side of the packaging material is in contact with food.

In another embodiment of the arrangement, one or more parts of the packaging machine being in contact with the first side of the prepared packaging material during operation of the packaging machine do not get in contact with the second side of the prepared packaging material. The advantages stated above remains the same. Additionally, if ink from the printing of the first side of the packaging material is scraped off and transferred or transported onto components or parts of the packaging machine, it cannot end up on the second side of the packaging material.

The infeed may comprise at least two reels and a splicing unit for splicing an end portion of prepared packaging material of one reel to a start portion of prepared packaging material of the second reel. Thus, the arrangement can be up and running continuously and requires no stop when the prepared packaging material of one reel is finished and the reel is to be replaced with a new one.

The prepared packaging material may comprise at least one of the following: a printed area on the first side at least partially surrounding an area to be printed upon by the digital printing system, one or more crease lines, at least one optical marker for positioning the prepared packaging material in the digital printing system and/or packaging machine, at least one magnetic marker for positioning the prepared packaging material in the digital printing system and/or packaging machine, a carton layer and one or more lamination layers on each side of the carton layer, an aluminium layer facing the second side of the prepared packaging material, a dedicated opening area, which comprises at least one layer of the prepared packaging material less than the surrounding material. The features stated above will increase the possibility to customize the packages and make it easier to control and monitor the printing process of the digital printing system.

The digital printing system may comprise a mechanical and/or an optical and/or magnetic positioning system adapted to evaluate the relative position of the prepared packaging material in view of one or more markers arranged on the prepared packaging material and/or geometric elements of the same prepared packaging material, thereby improving the accuracy of the digital printing system. Examples of suitable geometric elements are e.g. the edge of the web for alignment, crease detection, an opening area, etc. Further, the digital printing system may be adapted to print a marking on the first side of the packaging material, said marking to be read by the packaging machine during operation.

The digital printing system may be arranged on a movable platform or a removable module and its outfeed may comprise a separable interface for coupling the digital printing system to another packaging machine. The movable platform or a removable module increases the flexibility of these types of arrangements. One single digital printing system may accordingly be used in connection with several different arrangements, thereby saving manufacturing costs.

The digital printing system may comprise one or more encapsulated areas, said areas being adapted to operate in a food handling environment. The encapsulation will ensure that no printing material, such as ink or the like, will come into contact with the food.

A dedicated mechanism may be adapted to prevent migration of substances from an inside of said encapsulated area to an outside in order to ensure that no unwanted substances come into contact with the second side of the prepared packaging material. The mechanism may e.g. be a gas flow, a pressure difference or a mechanical solution for preventing substances to leave the encapsulated area or any foreseeable combination of such mechanisms.

The packaging machine may comprise one selected from the group consisting of a packing machine for web based filling material, a filling machine for sheet based packaging material, a web based tube filling machine, and a tube based filling machine.

In yet another embodiment of the arrangement, the packaging machine may comprise a splicing unit for splicing together prepared packaging material from two reels, and a bypass for feeding in prepared packaging material from the digital printing system, wherein the splicing unit is adapted to splice prepared packaging material from the digital printing system to other prepared packaging material.

The packaging machine may comprise a curing device for finalizing polymerization of ink used in the digital printing system, thereby making the print more resistant to wear. The curing device and the subsequent impact in polymerization may further have a direct positive contribution to the food safety characteristics of the final processed packaging material. The curing device may comprise an electron beam device but it may be any form of a classic dryer making use of energy emitted in different suitable wavelengths with our without additional air/gas flow.

The arrangement may further comprise a package material buffer between the digital printing system and the packaging machine for compensating speed fluctuations in the packaging machine in order to further secure the correct positioning of the print on the package.

The arrangement may preferably be placed in a food handling environment, particularly in a diary.

Generally, all terms used in the claims are to be interpreted according to their ordinary meaning in the technical field, unless explicitly defined otherwise herein. All references to “a/an/the [element, device, component, means, step, etc.]” are to be interpreted openly as referring to at least one instance of said element, device, component, means, step, etc., unless explicitly stated otherwise.

### BRIEF DESCRIPTION OF THE DRAWINGS

The above objects, as well as additional objects, features and advantages of the present invention, will be more fully appreciated by reference to the following illustrative and non-limiting detailed description of preferred embodiments of the present invention, when taken in conjunction with the accompanying drawings, wherein:

FIG. 1 is a schematic view of the arrangement adapted to package a liquid consumable product according to a first embodiment.

### DETAILED DESCRIPTION OF PREFERRED EMBODIMENTS OF THE INVENTION

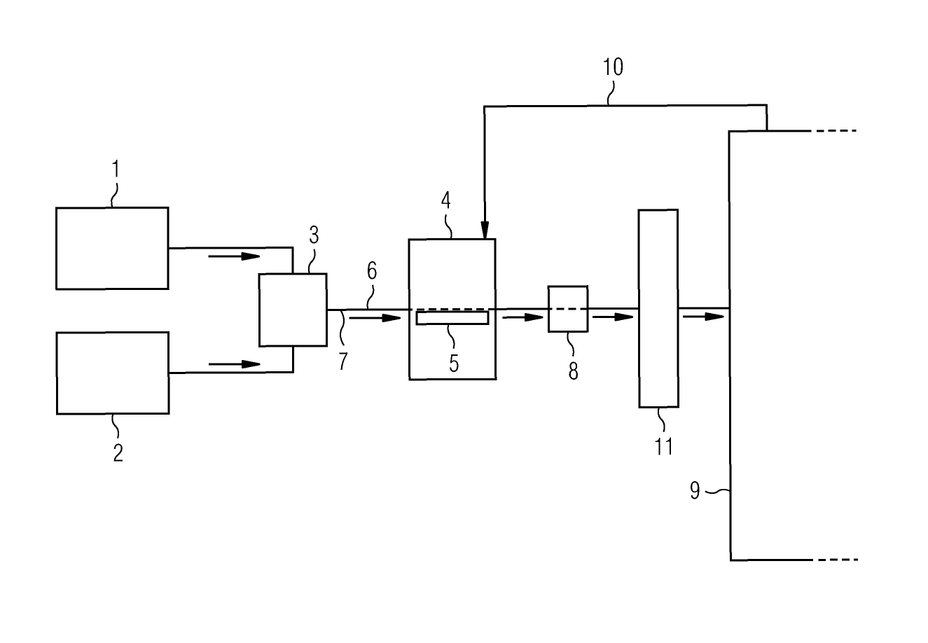

FIG. 1 is a schematic view of an arrangement adapted to package a liquid consumable product according to a first embodiment of the invention. A first reel 1 of packaging material and a second reel 2 of packaging material are connected to a splicing unit 3. Packaging material is used from one reel at a time. When one of the reels 1, 2 are out of packaging material, the splicing unit 3 will splice the end of the packaging material from the reel 1, 2 that is empty to the beginning of the packaging material of the full reel 1, 2. After the splicing, the empty reel 1, 2 may be replaced with a full reel 1, 2. In that way the machine does not have to be stopped when a new reel 1, 2 is attached.

The feed of packaging material after the splicing unit 3 is fed to the digital printing system 4. The digital printing system 4 prints on a portion of a first side 6 of the packaging material corresponding to each individual package enabling the possibility of a unique printing design on each package to at least some part. The second side 7 of the packaging material is intended to be in contact with the food.

The printing system 4 preferably contains one or more encapsulated areas 5 adapted to enhance the fulfillment of food handling requirements. The encapsulated areas 5 may be provided with a gas flow to provide elevated sub-pressure in the encapsulated area 5 so that an inward directed flow of gas to the encapsulated area 5 is induced, ensuring that unwanted substances cannot exit the encapsulated area 5 and endanger the second side 7 of the packaging material. The encapsulated area 5 of the digital printing system 4 may be provided to the first side 6 of the packaging material. Encapsulation may further be provided by other means than a gas flow, for example a suitable mechanical arrangement and or the usage of appropriately designed seals.

A curing device 8 may be applied to the feed of packaging material after the printing system 4 to cure the print on the first side 7 of the packaging material. The curing device 8 may also function as a disinfecting and sterilizing device to sterilize the packaging material. The curing device 8 could e.g. be a low voltage electron beam device both curing the ink printed onto the first side 6 of the packaging material and sterilizing the packaging materials on both sides 6, 7.

Additionally, the arrangement has a packaging machine 9 coupled to an outfeed of the digital printing system 4. The packaging machine 9 is adapted to provide a package from said prepared packaging material, which package is to be filled with the consumable product.

A package material buffer 11 may also be placed in the feed of packaging material between the digital printing system 4 and the packaging machine 9. The buffer 11 may be made of a number of movable rolls that may alter the infeed of packaging material to the packaging machine 9 to synchronize the packaging machine 9 so that the printed packaging material is positioned exactly right in the machine 9 and thus on the produced packages. The same buffer 11 may compensate eventual speed fluctuations between the packaging machine 9 and the printing system 4.

The arrangement may further be equipped with a feedback and control signal 10 from the packaging machine 9 to the digital printing system 4.

According to a further embodiment of the present invention a bypass is provided from two packaging material reels for connecting the digital printing system 4. An operator may in the splicing process, when changing reel 1, 2, choose if the next reel 1, 2 with pre-printed packaging material should be used or if packaging fed from the digital printing system 4 should be splice onto the feed so that the packaging machine 9 may change its production to produce instantly customizable printed packages in a seamless fashion. Naturally a third reel with packaging material then has to be provided for feeding packaging material to the digital printing system 4.

It is understood that other variations in the present invention are contemplated and in some instances, some features of the invention can be employed without a corresponding use of other features. It is e.g. understood that a person skilled in the art understands that all different possibilities are contemplated of having the printing system 4 and respective encapsulation 5 and curing device 8 to be all part of a standalone unit, a semi-autonomous unit, or autonomous movable platform, as well as being a full integral part of the packaging system in a modular or fully integrated manner. Accordingly, it is appropriate that the appended claims be construed broadly in a manner consistent with the scope of the invention.

1. An arrangement adapted to package a liquid consumable product in a package comprising:
an infeed configured to provide prepared packaging material including a first side and a second side adapted to be in contact with the liquid consumable product;
a digital printing system coupled to the infeed and adapted to print at least one color onto at least a portion of the first side of the prepared packaging material;
a packaging machine coupled to an outfeed of the digital printing system and adapted to provide a package from said prepared packaging material, said package configured to be filled with the liquid consumable product;
wherein the digital printing system is arranged with respect to the packaging machine such that contact between the printed first side of the prepared packaging material and a portion of the second side can be avoided during transport of the printed prepared packaging material from the digital printing system to the packaging machine.

2. (canceled)

3. The arrangement according to claim 1, wherein the infeed comprises at least two reels and a splicing unit configured to splice an end portion of prepared packaging material of one reel to a start portion of prepared packaging material of the second reel.

4. The arrangement according to claim 1, wherein the prepared packaging material comprises at least one of the following:
a printed area on the first side at least partially surrounding an area to be printed upon by the digital printing system;
one or more crease lines;
at least one optical marker for positioning the prepared packaging material in the digital printing system and/or packaging machine;
at least one magnetic marker for positioning the prepared packaging material in the digital printing system and/or packaging machine;
a carton layer and one or more lamination layers on each side of the carton layer;
an aluminium layer facing the second side of the prepared packaging material; or
a dedicated opening area, which comprises at least one layer of the prepared packaging material less than the surrounding material.

5. The arrangement according to claim 1, wherein the digital printing system comprises a mechanical and/or an optical and/or magnetic positioning system adapted to evaluate the relative position of the prepared packaging material in view of one or more markers arranged on the prepared packaging material and/or geometric elements of the same prepared packaging material.

6. The arrangement according to claim 1, wherein the digital printing system is adapted to print a marking on the first side of the packaging material, said marking to be read by the packaging machine during operation.

7. The arrangement according to claim 1, wherein the digital printing system is arranged on a movable platform and its outfeed comprises a separable interface for coupling the digital printing system to another packaging machine.

8. The arrangement according to claim 1, wherein the digital printing system comprises one or more encapsulated areas, said areas being adapted to operate in a food handling environment.

9. The arrangement according to claim 8, wherein said encapsulated areas comprises a dedicated mechanism adapted to prevent migration, transport or transfer of substances from an inside of said encapsulated areas to an outside.

10. The arrangement according to claim 1, wherein the packaging machine comprises one of:
a filling machine for web based packaging material;
a filling machine for sheet based packaging material;
a web based tube filling machine; and
a tube based filling machine.

11. The arrangement according to claim 1, wherein the packaging machine comprises:
a splicing unit for splicing together prepared packaging material from two reels; and
a bypass for feeding in prepared packaging material from the digital printing system;
wherein the splicing unit is adapted to splice prepared packaging material from the digital printing system to other prepared packaging material.

12. The arrangement according to claim 1, wherein the packaging machine comprises a curing device configured to finalize polymerization of ink used in the digital printing system.

13. The arrangement according to claim 12, wherein the curing device comprises an electron beam device.

14. The arrangement according to claim 1, further comprising:
a package material buffer between the digital printing system and the packaging machine, the package material buffer configured to compensate speed fluctuations in the packaging machine and/or synchronize a position of the printed packaging material with the packaging machine.

15. The arrangement according to claim 1, wherein the arrangement is placed in a food handling environment, particularly in a diary.

16. An arrangement adapted to package a liquid consumable product in a package comprising:
an infeed configured to provide prepared packaging material having a first side and a second side adapted to be in contact with the consumable product;
a digital printing system coupled to the infeed and adapted to print at least one color onto at least a portion of the first side of the prepared packaging material; and
a packaging machine coupled to an outfeed of the digital printing system and adapted to provide a package from said prepared packaging material, said package filled with the consumable product;
wherein the packaging machine is arranged such that contact between one or more parts of the packaging machine that are in contact with the first side of the prepared packaging material, and the second side of the prepared packaging material can be avoided during operation of the packaging machine.
